(19) United States
(12) Patent Application Publication
(10) Pub. No.: US 2015/0352559 A1
(43) Pub. Date: Dec. 10, 2015

(54) METHOD FOR MANUFACTURING CERTAIN PARTICLES, SUCH AS FRACKING SAND FROM SOLID PARTICLES

(71) Applicant: PRECISION SAND LTD., Vancouver (CA)

(72) Inventors: Andrew Sherliker Bamber, Vancouver (CA); Bahjat Khoshaba, Richmond (CA)

(21) Appl. No.: 14/789,835

(22) PCT Filed: Jan. 3, 2014
(86) PCT No.: PCT/CA2014/050004

§ 371 Date: Jul. 1, 2015

Related U.S. Application Data
(60) Provisional application No. 61/748,756, filed on Jan. 4, 2013.

(51) Int. Cl. B02C 23/10; B07B 1/00; B07B 15/00; B02C 23/18; B24B 31/02

(52) U.S. Cl. CPC B02C 23/10; B02C 23/18; B24B 31/02; B07B 15/00; B07B 1/00

(57) ABSTRACT

Systems and methods for comminution and shaping of solid particles in order to provide suitable fracking sands are disclosed. The systems and methods can include the use of a two-action scrubber designed to simultaneously rotate and move up and down in a vertical direction in order to promote interaction between the solid particles and the media. The scrubber can also use large particles separated from the feed stream as the media used to comminute and shape the particles fed into the scrubber for treatment.

### CROSS-REFERENCE TO RELATED APPLICATION(S)

This application claims the benefit under 35 U.S.C. §119(e) of U.S. Provisional Application No. 61/748,756, filed on Jan. 4, 2013, entitled “Method for Manufacturing a Fracking Sand From Siliceous Rock,” which is hereby incorporated by reference for all purposes in its entirety.

### BACKGROUND

In the field of oil and gas (fracking) applications, the American Petroleum Institute (API) has developed Recommended Practices (RP) for, inter alia, the shape, strength, and size distribution of “fracking” sands to be used in specific fracking applications. Of specific note is API RP 56 classification for 12/20#, 20/40#, 40/70#, and 70/140# fracking sands.

Silica sand naturally meeting API RP specifications is usually extracted from alluvial or sedimentary deposits. Such silica sand need only be disaggregated, scrubbed, and screened into various fractions of sand in order to meet API specifications, such as those described in RP 56.

Silica mined from other sources, however, does not typically naturally meet API RP specifications. For example, silica reposing in metamorphic, meta-sedimentary, or igneous intrusive deposits (such as chert or quartzite) typically needs to be subjected to a combination of comminution (size reduction), shaping, and size classification steps in order to produce silica particles collectively meeting the size and shape requirements of a fracking sand as described by, for example, API RP 56 (or other relevant standards such as ISO 13503-5:2006).

Accordingly, a need exists for methods and systems capable of carrying out the comminution, shaping, and size classification of silica which does not naturally meet API RP specifications for use as fracking sand, as well as providing other benefits. Overall, the examples herein of some prior or related methods/systems and their associated limitations are intended to be illustrative and not exclusive. Other limitations of existing or prior systems may become apparent to those of skill in the art upon reading the following Detailed Description.

### BRIEF DESCRIPTION OF THE DRAWINGS

FIG. 1 illustrates a method for sizing and shaping silica according to various embodiments described herein.

FIG. 2 illustrates a system suitable for use in sizing and shaping silica according to various embodiments described herein.

FIG. 3 illustrates a two-action grinding apparatus suitable for use in sizing and shaping silica according to various embodiments described herein.

### DETAILED DESCRIPTION

Described below is a method of comminution (size reduction) and abrasion by mechanical means to appropriately size and shape material, such as pre-crushed silica particles not necessarily meeting API specifications into particles meeting the API specification for use as a fracking sand. The method includes rejection by screening of silica particles too large to be treated, crushing the screened undersize material, screening of the crusher discharge into autogenous feed and recycle; and splitting of the recycle into a (minor) media fraction, and major crusher feed fraction. Further, the method includes crushing of the crusher feed fraction to a size appropriate for autogenous grinding, and autogenous grinding of the combined screen underflow in a two-action autogenous grinding mill, using silica material as the grinding media, in closed circuit with a screen. Screen underflow is classified by size using, e.g., a hydrocyclone. Cyclone underflow is delivered to the dryer for removal of water prior to classification of the silica product into various classes of fracking sand. Cyclone overflow is dewatered and delivered to the waste facility for disposal.

Also disclosed are a system for carrying out a comminution and abrasion process to appropriately size and shape silica particles for use as a fracking sand is disclosed and a two-action grinding apparatus suitable for use in a comminution and abrasion process.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

In the present disclosure, silica is used as a representative material to describe the various processing steps, systems, and apparatus that can be used to appropriately size and shape the material for use, e.g. as a fracking sand. However, the embodiments described herein are not limited to use on silica. Other minerals suitable for use in, e.g. fracking sands, can also be shaped and sized using the embodiments described herein and the present disclosure should not be interpreted as being limited for use on silica only.

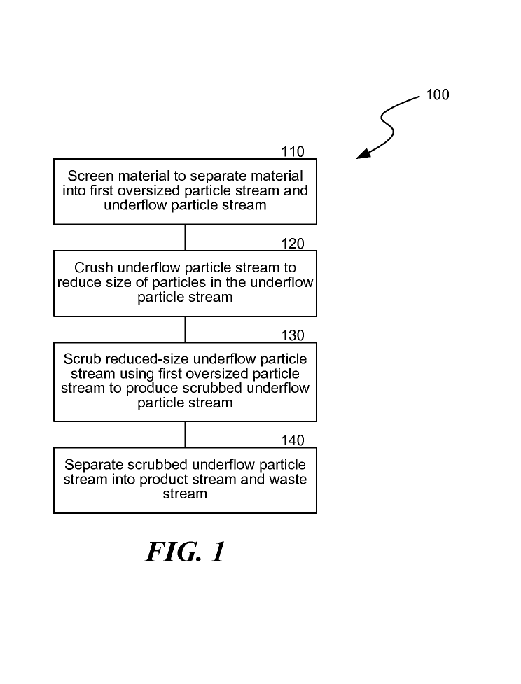

Referring now to FIG. 1, a method 100 suitable for sizing and shaping particles, including mineral materials such as silica includes a step 110 of screening the material to separate the material into a first oversized particle stream and an underflow particle stream; a step 120 of crushing the underflow particle stream to reduce the size of the particles in the underflow particles stream; a step 130 of scrubbing the reduced-size underflow particle stream using the first oversized particle stream to produce a scrubbed underflow particle stream; and a step 140 of separating the scrubbed underflow particle stream into a product stream and a waste stream.

In step 110, a material feed is provided and subjected to a screening process that separates the material feed based on the size of the particles. The material feed is generally a material of hard particles having a variety of sizes and shapes. In some embodiments, the material includes particles having a variety of sizes and shapes that would not be suitable for use as a fracking sand without further manipulation of the size and shape of the particles. The material feed can be any material suitable for use as a fracking sand. In some embodiments, the material is a mineral material, such as silica.

The screening step 110 is generally designed to separate the particles of the feed material based on the size of the particles. For example, the screening step may separate the feed material into two separate streams based on the particles being above or below a predetermined size. The screening step can be carried out using any apparatus suitable for use in separating particles based on size. In some embodiments, the screening step 110 is carried out using a screen. The specific type of screen used in the method is generally not limited. Different screens can be used to adjust the size of particle that is allowed to pass through the screen and thereby separate the feed material into two streams. Generally speaking, the mesh size of the screen will adjust the size of the particle allowed to pass through the screen. In some embodiments, screening step 110 is aimed at separating oversized particles from the feed material. In some embodiments, the screening step can be designed to separate particles having a size of greater than 2 mm to 4 mm nominal diameter.

Prior to screening step 110, optional pre-screening and pre-crushing steps can be carried out on the feed material to render the feed material into better condition for screening step 110. In some embodiments, the feed material is subjected to at least one pre-screening and one pre-crushing stage prior to screening step 110. The pre-screening step can be carried out to remove particles that are too large to be useful for any part of the method described herein. The large particles removed in the pre-screening step may be treated as waste material or may be subjected to specialized crushing steps to attempt to get the particles into a size that will be suitable for use in the method described herein. Once subjected to a pre-screening step, the underflow can be subjected to a pre-crushing step aimed at reducing the size of the particles prior to screening step 110. Any crusher apparatus suitable for use in reducing the size of hard particles can be used.

Screening step 110 generally produces a first oversized particle stream and an underflow particle stream. The first oversized particle stream is collected and transported to the scrubber apparatus described in greater detail below for use as a scrubbing media. The underflow particle stream can be subjected to a crushing step 120. The crushing step 120 is aimed at further reducing the size of the particles in the underflow particle stream. Any crushing apparatus suitable for use in crushing hard particles can be used to carry out the crushing step 120. In some embodiments, the crushing step 120 is aimed at reducing the size of the particles in the underflow particle stream to less than 25 mm for coarse fracking applications or 12.5 mm for finer fracking applications.

In scrubbing step 130, the reduced-size underflow particle stream is subjected to scrubbing in order to further reduce the size of the particles as well as to shape the particles. The scrubbing step 130 generally involves impacting the particles with a media that reduces the size of the particles and alters the shape of the particles, such as smoothing out rough edges. In some embodiments, the media used in scrubbing step 130 is the oversized particle stream produced in the screening step 110. At any time, between 5% and 30% by volume of the vessel used in scrubbing step 130 can be occupied by media to effect particle sizing and shaping during scrubbing. The scrubbing step 130 can also be facilitated by adding water to the underflow particle stream such that the media and the particles are suspended in a fluid when impacting each other.

In some embodiments, the scrubbing step 130 is carried out in a closed vessel, such as a cylindrical drum. Scrubbing step 130 can also be facilitated by subjecting the cylindrical drum to different types of motion that promote interaction between the media and the particles. In some embodiments, the vessel is rotated to cause tumbling of the particles and the media contained therein. In some embodiments, the vessel is subjected to vertical upward and downward motion to further promote interaction between the media and the particles. In some embodiments, these two types of motion are carried out simultaneously, although the different motions can also be carried out separately and sequentially. The rate at which the vessel is rotated is generally not limited. In some embodiments, the vessel is rotated at a rate of from 65% to 85% of critical speed (N_{c}) where Nc is calculated according to Equation (1):

$$N c = \frac{1}{2 π} \sqrt{\frac{g}{R - r}} \qquad ( 1 )$$

In Equation (1), g is gravitational acceleration, R is the diameter of the vessel in meters, and r is the nominal diameter of the media in meters.

The distance and frequency of lowering and raising the vessel is also generally not limited. In some embodiments, the vessel is moved a distance of from 1 mm to 10 mm in a vertical direction and a frequency of between 15 Hz and 120 Hz.

Scrubbing step 130 generally results in a portion of the particles being sized and shaped to within a desirable range for use as, for example, a fracking sand. However, not all of the particles will be sized and shaped to within the desired range, and therefore a second separation step 140 can be carried out to separate the final product from a waste stream. In some embodiments, the separation step 140 is aimed at separating particles too small for use in fracking sand. The separation step 140 can be carried out using any suitable separation apparatus. In some embodiments, separation step 140 is carried out in a hydrocyclone classifier. The hydrocyclone classifier can be designed to carry out a separation at a wide range of predetermined sizes. In some embodiments, a predetermined size is selected and the hydrocyclone classifier separates particles below this size to a hydrocyclone overflow and particles above this size to a hydrocyclone underflow. In some embodiments, the predetermined size is 210 microns for coarse fracking applications or 105 microns for fine fracking applications.

Optionally, the method can include an additional separation step that takes place after the scrubbing step 130 but prior to the second separation step 140. The aim of this step is to separate larger particles from the scrubbed material leaving the scrubber and to send these larger particles back to the scrubber to be scrubbed again. This separation step can be carried out using any suitable separation apparatus, including a screen. Once the larger particles are separated from the scrubbed underflow particle stream, the larger particles are transported back into the scrubber while the scrubbed underflow particle stream proceeds to the second separation step 140.

The hydrocyclone overflow of fine particles below the minimum predetermined size can be treated as a waste material. In some embodiments, the waste material is treated to remove water content from the overflow and produce dry fine solids. Any technique or apparatus suitable for separating water from the overflow can be used. In some embodiments, a thickener is used to remove water from the overflow. The removed water content can then be recycled back to the scrubber for use in the scrubbing step 130. The dewatered fine solids can then be disposed as waste material. Alternatively, the dewatered fine solids can be used in other applications, such as filler material, cement, or silica flour.

The hydrocyclone understream exiting the hydrocyclone classifier can generally include the final product of particles sized and shaped to within a desired range making the particles suitable for use as a fracking sand. In some embodiments, an optional additional step can be carried out to dry the underflow and produce dry solid particles suitable for use in fracking sands. Any suitable technique or apparatus can be used to dry the underflow. Additional separation steps can also be carried out to divide the solid particles into various fractions, such as through the use of screens and/or other size classifiers.

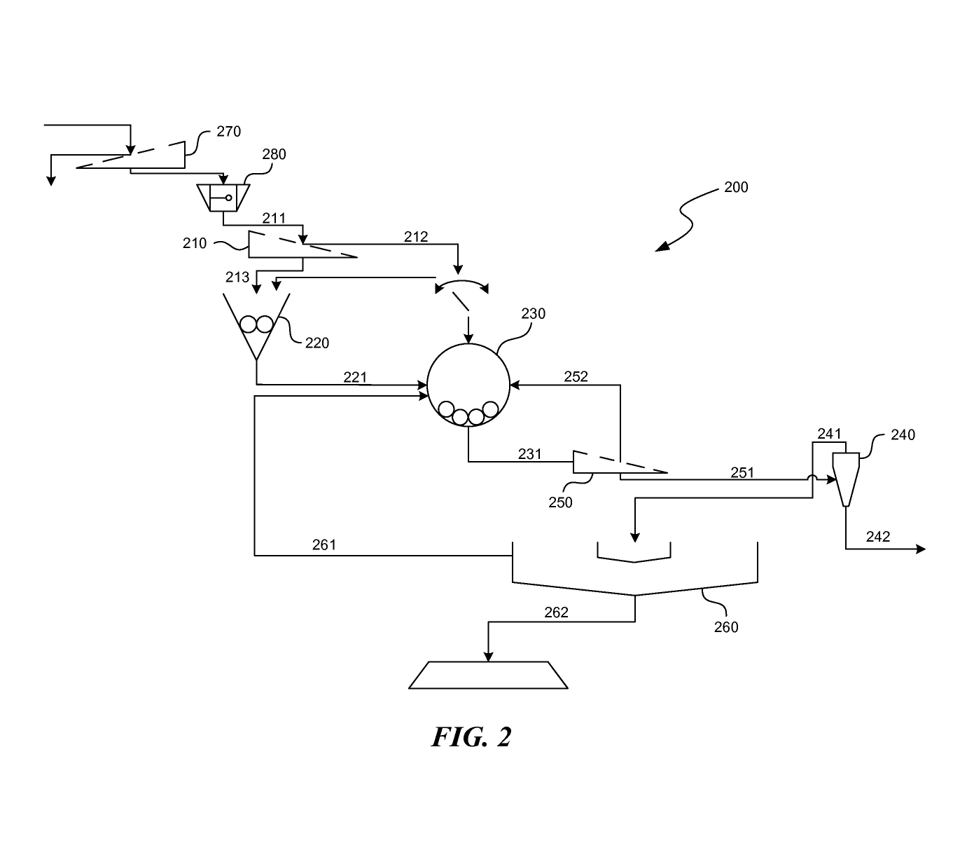

With reference to FIG. 2, a system 200 for carrying out the various embodiments of the method described above is illustrated. The system 200 generally includes a first separator 210, an impact crusher 220, a scrubber 230, and a hydrocyclone classifier 240, although additional optional equipment (described below) can also be included.

The first separator 210 can include any separator suitable for use in separating a feed material stream 211 including particles of various sizes based on the size of the particles. In some embodiments, the first separator 210 is a screen. The screen may have a mesh size which allows particles below a predetermined size to pass through the screen while retaining and separating particles above the predetermined size to thereby produce an oversize particle stream 212 and an underflow particle stream 213. Screens having different mesh sizes can be used to allow variability in the characteristics of the oversize particle stream 212 and the underflow particle stream 213. Based on the function performed by the first separator 210, the first separator may include a feed material inlet, an oversize particle stream outlet, and an underflow particle stream outlet.

The impact crusher 220 can include any type of crusher suitable for use in reducing the size of solid particles. Design parameters of the impact crusher can be adjusted to adjust the size of the particles produced by the crushing action and accommodate various desired end products, e.g., feed rate, feed size, rotor speed, liner selection, and closed-side setting. The impact crusher 220 can generally include an inlet in fluid communication with the underflow particle stream outlet, and thereby receive the underflow particle stream 213. The impact crusher produces a reduced-size underflow product stream 221 and can therefore include a reduced-size underflow product stream outlet.

A scrubber 230 is provided in order to further reduce the size of the particles leaving the impact crusher 220 as well as to shape the particles, such as by smoothing the particles. Any scrubber suitable for use in reducing the size of particles and shaping the particles can be used. Generally, the scrubber 230 will include a closed vessel in which the particles received from the impact crusher 220 can be impacted with a media that reduces the size of the particles and polishes the particles. Any media suitable for use in reducing the size of solid particles and shaping the solid particles can be used in the scrubber 230. In some embodiments, water is also used in the scrubber so that the particles and media are suspended in a liquid when impacting each other.

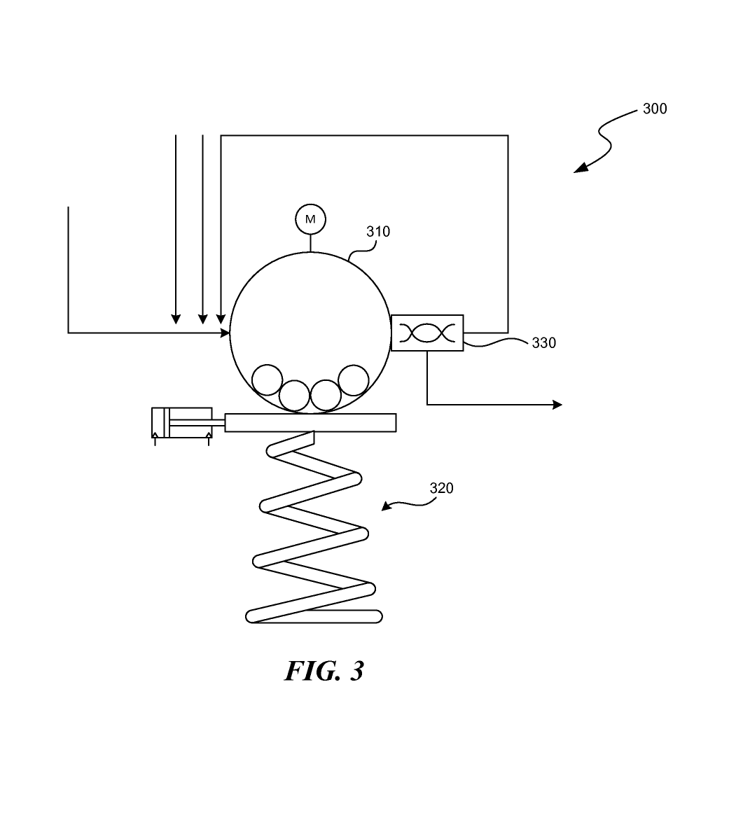

In some embodiments, the scrubber 230 is a two-action autogenous scrubber. The two-action autogenous scrubber is capable of rotating about a central axis so that the particles contained within the scrubber can be tumbled to promote interaction with the media. The two-action autogenous scrubber can also be capable of vertical up and down motion to further promote interaction between the particles and the media. In some embodiments, this vertical up and down motion is achieved through the use of reciprocating base frame upon which the closed vessel capable of rotating about a central axis rests. Further details regarding the two-action autogenous scrubber are provided below in the discussion of FIG. 3.

In some embodiments, the media used in the scrubber 230 is the oversize particle stream 212. The oversize particle stream 212 can be useful as a media for reducing the size of particles and shaping the particles due to their relatively large size as well as the common physical properties of particles in the underflow particle stream. Oversize particles from the oversize particle stream 212 are particularly well suited to the media application, as the oversize particles are hard and grind the fine particles effectively. Additionally, the oversize particle stream is sourced from the feed stream, so it is a cost-effective source of high quality grinding media for the process.

Because the scrubber 230 receives the reduced-size underflow particle stream 221 and the oversized particle stream 212, the scrubber will generally include a first inlet in fluid communication with the reduced-size underflow particle stream outlet of the impact crusher 220, and a second inlet in fluid communication with the oversized particle stream outlet of the first separator 210. The scrubber produces a scrubbed underflow particle stream 231 and therefore can include a scrubbed underflow particle stream outlet.

In some embodiments, the scrubbed underflow particle stream 231 is sent to a hydrocyclone classifier 240 for separating fine particle solids from the particle solids suitable for use in fracking sands. The hydrocyclone classifier 240 can be any hydrocyclone classifier suitable for separating the particles of the scrubbed underflow particle stream 231 based on size. In some embodiments, the hydrocyclone classifier 240 is designed to separate all particles having a size below a predetermined size. For example, the hydrocyclone classifier 240 can be designed to separate particles having a size less than 210 microns for coarse fracking applications or 105 microns for fine fracking applications. In embodiments where the scrubbed underflow particle stream 231 is sent directly to the hydrocyclone classifier 240, the hydrocyclone classifier can include an inlet in fluid communication with the scrubbed underflow particle stream outlet of the scrubber 230. The hydrocyclone classifier can also include a waste stream outlet for the fine particle waste stream 241 and a product stream outlet for the product stream 242 including the particles sized and shaped for suitable use as fracking sand.

In alternate embodiments, a second separator 250 is positioned between the scrubber 230 and the hydrocyclone classifier 240 to carry out a separation step on the scrubbed underflow particle stream 231 prior to it being introduced into the hydrocyclone classifier 240. An aim of the second separator 250 can be to separate larger particles contained in the scrubbed underflow particles stream 231 and which would be best suited for recycling back in to the scrubber 230 to be used as media. The second separator 250 can be any type of separator suitable for use in separating particles from a stream based on size. In some embodiments, the second separator 250 is a screen having a mesh size similar to the mesh size of the first separator 210 so as to separate particles having a similar size as those separated in the first separator 210 and which are used as media in the scrubber 230. Based on the function of the second separator 250, the second separator 250 can generally produce an undersized particle stream 251 and a second oversized particle stream 252. Consequently, the second separator can include a scrubbed underflow particle inlet in fluid communication with the scrubbed underflow particle outlet of the scrubber 230, an undersized particle stream outlet in fluid communication with the inlet of the hydrocyclone classifier 240 and a second oversized particle stream outlet in fluid communication with a second oversized particle stream inlet provided in the scrubber 230.

The system 200 can further include an optional separator 260 for removing water from the waste product stream 251. Any suitable separator can be used for removing the water, including a thickener. The water 261 removed in the separator 260 can be transported back to the scrubber 230 for use in the scrubbing step. The dewatered waste 262 can be disposed of in accordance with various environmental regulations or can be used on various applications, such as filler, cement, or silica flour. Accordingly, the separator 260 can include a waste stream inlet in fluid communication with the waste stream outlet of the hydrocyclone classifier 240, a dewatered waste outlet, and a water outlet in fluid communication with a water inlet provided in scrubber 230.

The system 200 can further include an optional drying system (not shown) used to dry the product stream 242. Any drying system suitable for removing water from the product stream and providing a dry particle stream can be used. The system 200 can also optionally include additional separators for separating the dried product stream into particle fractions. The separation system can be any type of separation system capable of separating a particle stream based on particle size, including screens and classifiers.

Optional pre-screening and pre-crushing apparatus can also be provided in the system 200 for conditioning the feed material prior to being introduced into the first separator 210. For example, a screen 270 can be provided to remove large particles not suitable for use in the process described herein. Similarly, a pre-crusher can be provided to minimize the size of the particles to a threshold size required prior to carrying out the method described herein. While FIG. 2 illustrates one pre-screening apparatus and one pre-crushing apparatus, the system 200 can include any number of each type of equipment.

With reference to FIG. 3, a two-action autogenous scrubber 300 suitable for use in the methods and systems described herein is shown. The two-action autogenous scrubber generally comprises a main vessel 310 and a reciprocating base frame 320 upon which the main vessel 310 is positioned.

The main vessel 310 is a generally closed vessel that can receive the reduced-size underflow particle stream, along with a water stream and a media stream (which, in some embodiments, is the oversized particle stream). The main vessel is adapted for allowing and promoting interaction between the media and the particles in order to reduce the size of the particles and to shape the particles. The material, size, and shape of the main vessel 310 is generally not limited, and can include any material, size, and shape capable of containing the materials and allowing the media to interact with the particles. In some embodiments, the main vessel 310 has a cylindrical shape, including a central axis. The cylindrically shaped vessel 310 can rotate about the central axis in order to promote a tumbling action that promotes interaction between the media and the particles. The vessel can be rotated at any speed. In some embodiments, the vessel is rotated at a rate of from 65 to 80% of the critical speed previously defined by Equation (1).

The reciprocating base frame 320 can be any suitable reciprocating base frame which is capable of moving the main vessel vertically in an up and down motion. This motion is designed to further promote interaction between the media and the particles contained within the scrubber 300. The distance the reciprocating base frame 320 moves the main vessel is generally not limited. In some embodiments, the vertical distance is in the range of from 1 mm to 10 mm. The frequency at which the reciprocating base frame 320 moves (i.e., the time which it takes the reciprocating base to move the main vessel through one complete up and down cycle) is also generally not limited. In some embodiments, the frequency is in the range of from 15 Hz to 120 Hz.

The scrubber 300 can include a variety of inlets and outlets. In some embodiments, the scrubber 300 includes an inlet for the feed material, an inlet for the water stream, and an inlet for the media. One or more of these streams can also be combined prior to being introduced into the scrubber to thereby reduce the number of separate inlets. The scrubber 300 will also generally include at least one outlet for passing reduced sized and shaped particles out of the scrubber 300. In some embodiments, the product stream is passed directly from the scrubber into a separation unit 330. The separation unit 330 is provided to separate larger particles suitable for use as the media in the scrubber 300 from the reduced sized and shaped particles. Any suitable separator can be used, including a screen as described in greater detail above.

The scrubber 300 can include a variety of mechanical features. The vessel can be lined with wear linings (e.g., rubber) for protecting the vessel from the media and the product. The wear lining can be fitted with additional lifter bars for increased agitation of the vessel contents. In some embodiments, the vessel is located on a set of two large diameter journal bearings, and driven by means of a motor connected to a gear reducer, connected to an output shaft connected to a pinion gear inter-meshed with a large diameter ring gear affixed to the outer diameter of the vessel. In some embodiments, the vessel is mounted on supporting rollers, and driven via the rollers by means of a motor connected to a gear reducer, connected to one set of the supporting rollers. The vessel, mounting gear and drive gear are all mounted on a base frame which is in turn mounted on isolators (either spring steel or elastomer). The base frame can also be equipped with two electrical vibrating motors, one at either end, used to impart the vertical motion to the two-action scrubber 300.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines or subroutines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are shown as being performed in series, some processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112, sixth paragraph 112(f) (AIA), other aspects may likewise be embodied as a means-plus-function claim, or in other forms, such as being embodied in a computer-readable medium. (Any claims intended to be treated under 35 U.S.C. §112, ¶6(f) will begin with the words “means for”, but use of the term “for” in any other context is not intended to invoke treatment under 35 U.S.C. §112, ¶6(f).) Accordingly, the applicant reserves the right to pursue additional claims after filing this application to pursue such additional claim forms, in either this application or in a continuing application.

I/we claim:

1. A method of sizing and shaping a material, comprising:
screening the material to separate the material into first oversized particle stream and an underflow particle stream;
crushing the underflow particle stream to reduce the size of the particles in the underflow particle stream;
scrubbing the reduced-size underflow particle stream using the first oversized particle stream to produce a scrubbed underflow particle stream; and
separating the scrubbed underflow particle stream into a product stream and a waste stream.

2. The method of claim 1, wherein the material is mined silica, and wherein scrubbing is carried out using a water stream.

3. The method of claim 1, further comprising a step of screening the scrubbed underflow particle stream prior to separating the scrubbed underflow particle stream to separate a second oversized particle stream from the underflow particle stream, and wherein the second oversized particle stream is used in scrubbing the reduced-size underflow particle stream.

4. The method of claim 2, wherein the waste stream is a fine particle stream and water is removed from the fine particles stream and used in scrubbing the reduced size-underflow particle stream.

5. The method of claim 1, wherein the product stream is dried to remove water.

6. The method of claim 1, wherein scrubbing is carried out in an apparatus that simultaneously rotates about an axis and moves vertically up and down during the scrubbing.

7. A system for sizing and shaping a material, comprising:
a first separator having a material inlet, an oversized particle stream outlet, and an underflow particle stream outlet;
an impact crusher having an inlet in fluid communication with the underflow particle stream outlet of the first separator, and a reduced-size underflow particle stream outlet;
a scrubber having a first inlet in fluid communication with the reduced-size underflow particle stream of the impact crusher, a second inlet in fluid communication with the oversized particle stream outlet of the first separator, and a scrubbed underflow particle stream outlet; and
a hydrocyclone classifier having an inlet in fluid communication with the scrubbed underflow particle stream outlet of the scrubber, a waste stream outlet, and a product stream outlet.

8. The system of claim 7, wherein the scrubber rotates about an axis and moves vertically up and down.

9. The system of claim 8, further comprising a second separator having a scrubbed underflow particle stream inlet in fluid communication with the scrubbed underflow particle stream outlet of the scrubber, an undersized particle stream outlet in fluid communication with the scrubbed underflow particle stream outlet, and a second oversized particle stream outlet; and
wherein the scrubber further comprises a second oversized particle stream inlet in fluid communication with the second oversized particle stream outlet of the second separator.

10. The system of claim 9, wherein the first separator is a screen and the second separator is a screen.

11. The system of claim 7, wherein the scrubber further comprises a water inlet.

12. The system of claim 11, wherein the system further comprises a thickener including a waste stream inlet in fluid communication with the waste stream outlet of the hydrocyclone classifier, a water outlet in fluid communication with the water outlet of the scrubber, and a dewatered waste outlet.

13. The system of claim 7, further comprising a drying system having a product stream inlet in fluid communication with the product stream outlet of the hydrocyclone classifier.

14. A autogenous scrubber comprising:
a main vessel having a central axis, wherein the main vessel rotates about the central axis; and
a reciprocating base frame on top of which the main vessel is positioned, wherein the reciprocating base moves the main vessel vertically up and down;

15. The autogenous scrubber of claim 14, wherein the main vessel comprises a feed material inlet, an oversized material inlet, and a scrubbed material outlet.

16. The autogenous scrubber of claim 15, wherein the main vessel further comprises a water inlet.

17. The autogenous scrubber of claim 14, wherein the main vessel has a cylindrical shape.

18. The autogenous scrubber of claim 14, wherein the main vessel rotates at a rate of between 60% to 80% of critical speed (N_{c}).

19. The autogenous scrubber of claim 14, wherein the main vessel simultaneously rotates about the central axis and moves vertically up and down.

20. A system capable of sizing and shaping a material, comprising:
means for screening the material to separate the material into first oversized particle stream and an underflow particle stream;
means for crushing the underflow particle stream to reduce the size of the particles in the underflow particle stream;
means for scrubbing the reduced-size underflow particle stream using the first oversized particle stream to produce a scrubbed underflow particle stream; and
means for separating the scrubbed underflow particle stream into a product stream and a waste stream.
